(19) United States
(12) Patent Application Publication
(10) Pub. No.: US 2010/0099024 A1
(43) Pub. Date: Apr. 22, 2010

(54) METHOD FOR CONNECTION OF CONDUCTIVE MEMBER TO DEVICE

(76) Inventors: Hyeongchan Kim, Seoul (KR); Man-Chul Hur, Seoul (KR); Bong Hyup Kang, Seoul (KR); Hakjun Lee, Seoul (KR); Sain Park, Anyang-Si (KR); Yongho Cho, Seongnam-Si (KR)

Correspondence Address: BIRCH STEWART KOLASCH & BIRCH, PO BOX 747, FALLS CHURCH, VA, 22040-0747, US

(21) Appl. No.: 12/515,469

(22) PCT Filed: Oct. 19, 2007
(86) PCT No.: PCT/KR07/05133

§ 371 Date: Dec. 30, 2009

(30) Foreign Application Priority Data
Nov. 20, 2006 (KR) 10-2006-0114213

(51) Int. Cl. H01M 2/02; H01B 5/00; H01R 43/00

(52) U.S. Cl. 429/164; 429/178; 174/126.1; 29/825

(57) ABSTRACT

Disclosed herein are a method of coupling a conductive member for electric connection ('connection member) to a desired device by welding, wherein the connection member includes a corrosion prevention coating layer formed on a plate body of a high electrical conductivity and an embossed structure formed at one end thereof, and wherein the method comprises locating the connection member such that a protrusion of the embossed structure is brought into contact with a predetermined region of the device, at which the connection member will be connected to the device, making a welding rod come into contact with a depression opposite to the protrusion, and performing resistance welding, and a conductive connection member coupled by the coupling method. The coupling method has the effect of substituting for nickel, which has low price competitiveness, and solving the problems caused during the welding process, thereby greatly improving the productivity and greatly reducing a possibility of defect.

### FIELD OF THE INVENTION

The present invention relates to a method of coupling a conductive member for electric connection ('connection member) to a desired device by welding, wherein the connection member includes a corrosion prevention coating layer formed on a plate body of a high electrical conductivity and an embossed structure formed at one end thereof, and wherein the method comprises locating the connection member such that a protrusion of the embossed structure is brought into contact with a predetermined region of the device, at which the connection member will be connected to the device, making a welding rod come into contact with a depression opposite to the protrusion, and performing resistance welding, and a conductive connection member coupled by the coupling method.

### BACKGROUND OF THE INVENTION

As mobile devices have been increasingly developed, and the demand of such mobile devices has increased, the demand of secondary batteries has also sharply increased as an energy source for the mobile devices.

Depending upon the kinds of external devices in which the secondary batteries are used, the secondary batteries may be used in the form of a single battery or in the form of a middle- or large-sized battery pack having a plurality of unit cells electrically connected with each other. For example, small-sized devices, such as mobile phones, can be operated for a predetermined period of time with the power and capacity of one battery. On the other hand, a middle- or large-sized battery pack needs to be used in middle- or large-sized devices, such as laptop computers, electric vehicles, and hybrid electric vehicles, because high power and large capacity are necessary for the middle- or large-sized devices.

The middle- or large-sized battery pack is a battery structure in which a plurality of unit cells are electrically connected in series and/or in parallel with each other. A wire, plate, or flexible printed circuit board (FPCB) is generally used for electrical connection between electrodes of the respective unit cells.

The wire is a line-shaped conductive member. Generally, insulative resin is coated on the outer surface of the line-shaped member, and therefore, the wire has an advantage in that the wire is easily transformable and inexpensive. On the other hand, the wire has a disadvantage in that it is difficult to accomplish the electrical connection between the electrodes of the respective batteries and the wire by soldering or welding, such as spot welding, ultrasonic welding, or laser welding. Also, the wire has another disadvantage in that a large amount of heat is transmitted to the batteries, during the welding process or the soldering process, with the result that the batteries may be damaged.

The plate is a plate-shaped conductive member. The plate has an advantage in that the connection between the electrodes of the respective batteries and the plate is easily accomplished by welding. On the other hand, the plate has a disadvantage in that the coupling may be not accomplished with even a little error during an assembly process.

The FPCB, which has been recently increasingly used, has an advantage in that the connection between the electrodes of the respective batteries and the FPCB by welding is easily accomplished, like the plate, and the FPCB is suitable for the electrical connection of a complicated structure. On the other hand, the FPCB has a disadvantage in that the FPCB is expensive, the transformability of the FPCB is very low, and the assembly process is difficult.

FIGS. 1 and 2 are views typically illustrating a process for connecting a plurality of batteries to each other using a nickel plate.

Referring to FIG. 1, batteries 20 and 21 are fixed by a jig 10, a nickel plate 30 is located on an electrode terminal of the battery 20, and spot welding is carried out with a welding tip 40. The batteries 20 and 21 are connected in parallel with each other. Subsequently, as shown in FIG. 2, spot welding is carried out on another pair of parallel batteries 22 and 23. In order to connect the first parallel battery pair 20 and 21 and the second parallel battery pair 22 and 23, the first parallel battery pair 20 and 21 and the second parallel battery pair 22 and 23 are arranged at a right angle, the nickel plate 20 is bent by 90 degrees, and the nickel plate 30 is connected to the second parallel battery pair 22 and 23 by welding. This process is also carried out on a third parallel battery pair 24 and 25. Consequently, a very skilled technique and a jig of a special structure are needed, and the welding process is time-consuming. When the battery pairs 20, 21, 22, 23, 24, and 25 are spread in a line, after the welding process is completed, the batteries are arranged in a structure as shown in FIGS. 3 and 4.

FIG. 3 is a view typically illustrating a battery pack constructed in a structure in which the three battery pairs are arranged in a three-series and two-parallel connection fashion after the electrical connection between the batteries as shown in FIGS. 1 and 2. For the convenience of understanding, the three-series and two-parallel coupling structure of the battery pack is illustrated as an exploded view.

As shown in FIG. 3, the three battery pairs, each pair 20 and 21 of which are connected in parallel with each other, are connected in series with each other via the nickel plate 30.

FIG. 4 is a typical view illustrating a battery pack 50 the assembly of which is completed. The respective batteries 20 and 21 are connected to a protection circuit module 90 via a cathode conductive wire 60 and an anode conductive wire 70, which are connected to the nickel plate 30, and a FPCB 80.

In the conventional battery pack manufacturing method using the nickel plate as described above, the ‘nickel’ is used as a main material for the electrical connection member. However, the ‘nickel’ has low price competitiveness. In addition, the nickel has high internal resistance, and the transformability of the nickel is very low.

Therefore, much research is being actively carried out on materials to substitute for the nickel in order to solve the above-mentioned problems. For example, copper may be used, instead of the nickel, because the copper has high electrical conductivity and processability while the copper has high price competitiveness. However, the copper has a disadvantage in that the copper may corrode, and the high electrical conductivity of the copper disturbs sufficient generation of heat during a resistance welding process, whereby it is very difficult to perform the welding process with the copper. In addition, the copper may stick to a welding rod, during the welding process, with the result that the workability is greatly lowered, and a defect rate increases.

### SUMMARY OF THE INVENTION

Therefore, the present invention has been made to solve the above problems, and other technical problems that have yet to be resolved.

As a result of a variety of extensive and intensive studies and experiments to solve the problems as described above, the inventors of the present invention have developed a novel method of coupling a new conductive connection member capable of substituting for nickel to a desired device by welding, and have found that the coupling method has a high price competitiveness and is capable of solving problems caused during a welding process, thereby greatly improving the productability and greatly reducing a possibility of defect.

Specifically, it is a first object of the present invention to provide a novel welding method using a conductive connection member of a new structure that is capable of solving problems caused during a conventional welding process.

It is a second object of the present invention to provide a conductive connection member of a new structure and material that is capable of substituting for nickel, which is expensive.

In accordance with one aspect of the present invention, the above and other objects can be accomplished by the provision of a method of coupling a conductive member for electric connection ('connection member) to a desired device by welding, wherein the connection member includes a corrosion prevention coating layer formed on a plate body of a high electrical conductivity and an embossed structure formed at one end thereof, and wherein the method comprises locating the connection member such that a protrusion of the embossed structure is brought into contact with a predetermined region of the device, at which the connection member will be connected to the device, making a welding rod come into contact with a depression opposite to the protrusion, and performing resistance welding.

Consequently, the coupling method according to the present invention has the effect of preventing the corrosion of the connection member by the provision of the coating layer formed on the plate body and preventing the connection member from sticking to the welding rod by the provision of the embossed structure formed at one end of the connection, thereby greatly reducing the defect ratio.

The resistance welding is not particularly restricted so long as the resistance welding is carried out using a pair of welding rods. In a preferred embodiment, the resistance welding is carried out by a pair of welding rods having different electrode characteristics, one welding rod (a) being brought into contact with the depression of the connection member, the other welding rod (b) being brought into direct contact with the device.

As a power source for the resistance welding, an alternating current, a direct current, or a high-frequency current may be used. Although a current flow route is not particularly restricted, it is preferable that the electric current for the resistance welding flows successively through the welding rod (a), the connection member, the device, and the welding rod (b).

The device may be variously applicable to apparatuses that use electricity as an operating power source. In a preferred embodiment, the device is a secondary battery, and the connection member is coupled to an electrode terminal of the secondary battery by the resistance welding.

In accordance with another aspect of the present invention, there is provided a conductive connection member coupled to an electrode terminal of a secondary battery by resistance welding, wherein the connection member includes a corrosion prevention coating layer formed on a plate body of a high electrical conductivity and an embossed structure formed at one end thereof.

The embossed structure is a structure in which a protrusion and/or a depression is formed at one side or each side of a plate-shaped member. The embossed structure includes a structure in which the protrusion is formed at one side of the plate-shaped member, and the depression is formed at the opposite side to the protrusion.

In a conventional art, nickel, which is very expensive, is used as the conductive connection member for electric connection to the electrode terminal of the secondary battery. The use of the nickel increases the manufacturing costs of the battery.

Consequently, it is preferable to substitute an appropriate material for the nickel. In a preferred embodiment, the plate body is made of a metal material having an electrical conductivity greater than that of nickel, and the corrosion prevention coating layer is made of a tin-based material.

The electrical conductivity is related to specific resistance of metal. As the specific resistance value increases, the electrical conductivity decreases. Consequently, the metal material the electrical conductivity of which is greater than that of the nickel has a specific resistance value less than that of the nickel. As the metal material having an electrical conductivity greater than that of the nickel, for example, one or two selected from a group consisting of zinc, aluminum, and copper or an alloy thereof may be used. Preferably, the metal material having an electrical conductivity greater than that of the nickel is a copper-based material.

The copper-based material may be copper or an alloy containing copper as a main component (a copper alloy). For example, the copper alloy is oxygen free copper (OFC), brass (60/40 or 70/30), phosphorous bronze, or an alloy thereof.

The copper-based material has a high electrical conductivity and processability. Consequently, the copper-based material may be used as a superior electrical connection member. However, the following several problems may occur when the copper is used as the connection member. First, the copper may oxidize or corrode in the air. Secondly, heat is not sufficiently generated, during the resistance welding process, due to high electrical conductivity of the copper, whereby it is very difficult to perform the welding process for coupling the copper to the electrode terminal. The present invention solves the above-mentioned problems as follows.

In order to prevent the oxidation or corrosion, first, the corrosion prevention coating layer is formed on the plate body according to the present invention. The corrosion prevention coating layer may be made of tin or an alloy containing tin as a main component such that the electrical conductivity of the copper is not lowered while preventing the oxidation or corrosion. According to circumstances, the corrosion prevention coating layer may be made of nickel an alloy containing nickel as a main component.

Subsequently, the embossed structure is formed at one end of the connection member, according to the present invention, such that the resistance welding is easily carried out. When the embossed structure is formed at the region where the resistance welding will be carried out, supplied current concentrates on the protrusion of the embossed structure. As a result, the resistance value increases on the protrusion, and therefore, heat is generated from the protrusion in a concentrated fashion. Consequently, the temperature of the protrusion reaches a melting temperature. Also, the temperature of the protrusion reaches the melting temperature faster than that of the depression opposite to the protrusion, whereby the connection member is prevented from sticking to the welding rod.

The corrosion prevention coating layer is formed with a thickness sufficient to prevent the oxidation or corrosion of the plate body but not to restrict the electrical conductivity. Preferably, the corrosion prevention coating layer has a thickness of 2 to 8 μl.

According to circumstances, the corrosion prevention coating layer may be formed entirely or partially on one side or each side of the plate body. Preferably, however, the corrosion prevention coating layer is formed entirely on each side of the plate body to maximize the effect of preventing the oxidation or corrosion of the plate body.

The embossed structure is not particularly restricted so long as the connection member is appropriately coupled to the battery. Preferably, however, the embossed structure is formed in the shape of a hemispheric protrusion having a radius of 0.4 to 1 mm.

In accordance with a further aspect of the present invention, there is provided a secondary battery the electrical connection of which is accomplished using the connection member.

The secondary battery, to which the connection member is applicable, may be constructed in various forms. The secondary battery is preferably a cylindrical battery or a prismatic battery, more preferably a cylindrical battery.

The structure of the secondary battery and a manufacturing method thereof are well known in the art to which the present invention pertains, and therefore, a detailed description thereof will not be given.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are typical views illustrating a process for connecting a plurality of batteries to each other using a nickel plate according to a conventional art;

FIG. 3 is an exploded view illustrating the coupling between the batteries manufactured through the process shown in FIGS. 1 and 2;

FIG. 4 is a typical view illustrating a battery pack manufactured according to a conventional art;

FIG. 5 is a typical view illustrating a resistance welding process according to a preferred embodiment of the present invention;

FIG. 6 is a sectional view illustrating the multi-layer structure of a conductive connection member according to a preferred embodiment of the present invention;

FIG. 7 is a partial front view illustrating one end of a conductive connection member according to another preferred embodiment of the present invention; and

FIG. 8 is a partial sectional view illustrating an embossed structure of the conductive connection member shown in FIG. 7.

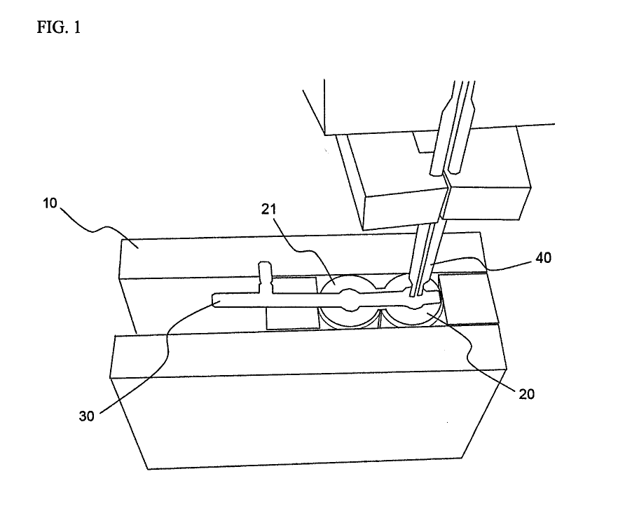

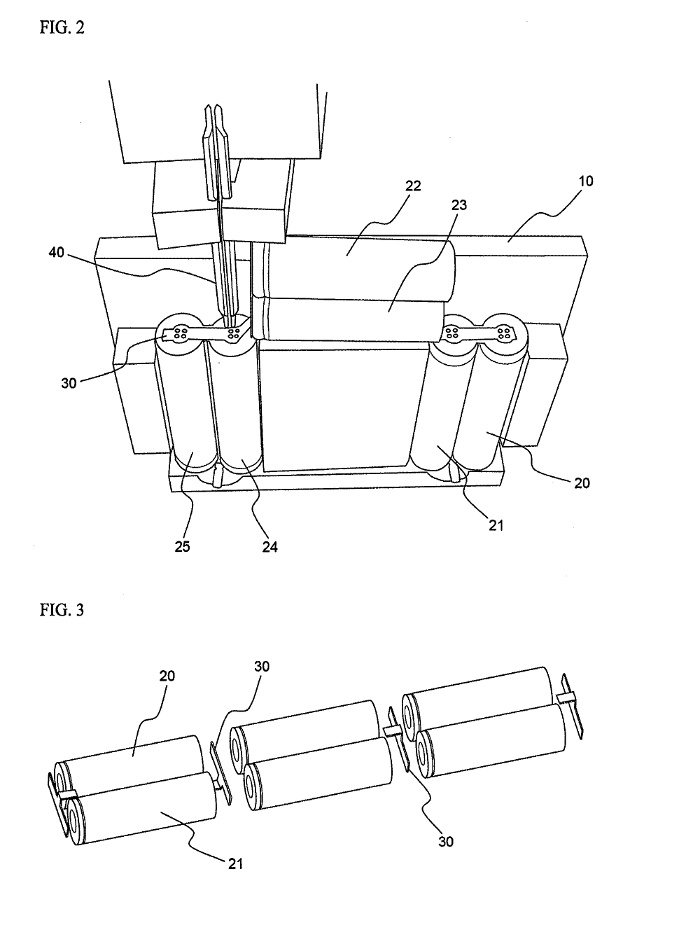

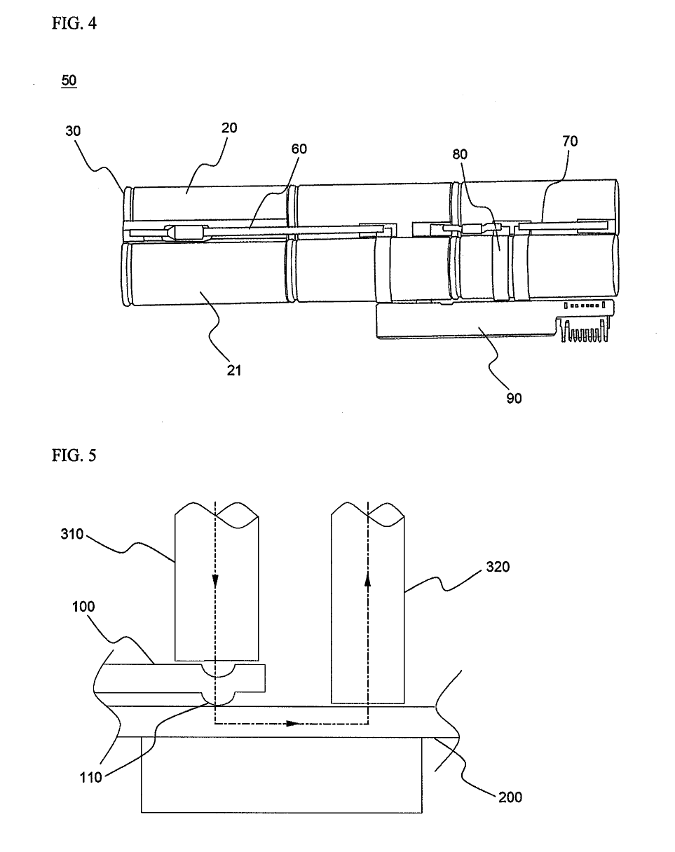

### DETAILED DESCRIPTION OF PREFERRED EMBODIMENTS

Now, preferred embodiments of the present invention will be described in detail with reference to the accompanying drawings. It should be noted, however, that the scope of the present invention is not limited by the illustrated embodiments.

FIG. 5 is a typical view illustrating a resistance welding process according to a preferred embodiment of the present invention.

Referring to FIG. 5, a conductive connection member 100 is located on the upper end of a battery 200. Also, a pair of welding rods 310 and 320 are in contact with the conductive connection member 100 and the upper end of the battery 200, respectively. Specifically, the conductive connection member 100 is arranged such that a protrusion 110 of an embossed structure is in contact with a predetermined region of the battery 200, at which the conductive connection member 100 will be connected to the battery 200, and a depression opposite to the protrusion 110 is directed upward.

A resistance welding process is carried out by the pair of welding rods 310 and 320. The welding rod 310 is in contact with the depression opposite to the protrusion 110, and the welding rod 320 is in contact with the upper end of the battery 200. The welding rods 310 and 320 have different electrode characteristics. Resistance welding current flows successively through the welding rod 310, the connection member 100, the battery 200, and the welding rod 320, to carry out the resistance welding process.

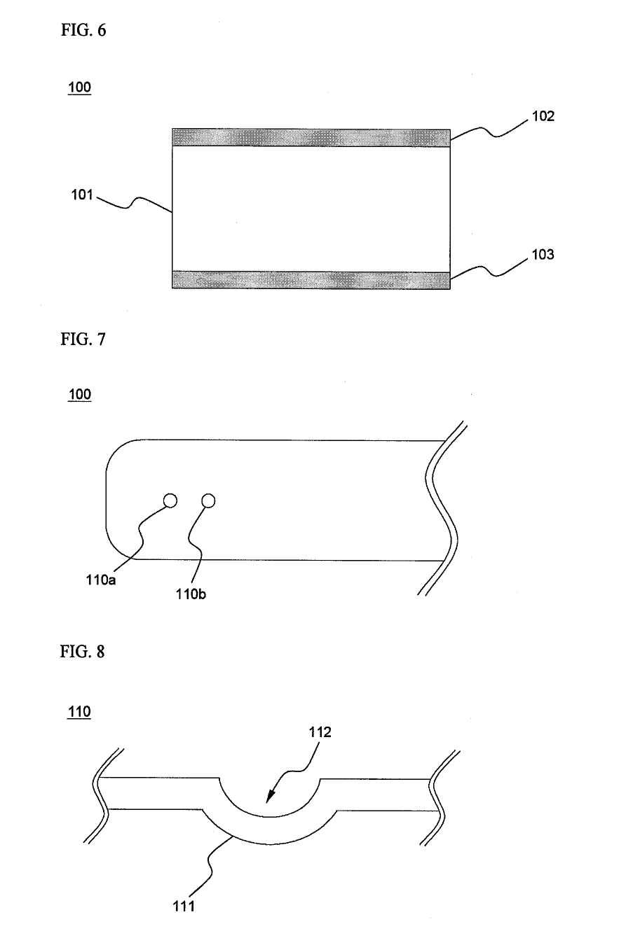

FIG. 6 is a sectional view illustrating the multi-layer structure of a conductive connection member according to a preferred embodiment of the present invention.

Referring to FIG. 6, tin coating layers 102 and 103 are formed on opposite sides of a plate body 101 made of copper. The coating layers 102 and 103 serve to prevent the oxidation and corrosion of the plate body 101 having the copper as the basic material. The coating layers 102 and 103 are formed entirely on the opposite sides of the plate body 101 such that the coating layers 102 and 103 have a thickness of 3 μm.

FIG. 7 is a partial front view illustrating one end of a conductive connection member according to another preferred embodiment of the present invention.

Two embossed structures 110a and 110b are formed at one end of the conductive connection member 100. The respective embossed structures 110a and 110b also serve as marks indicating welding positions where the conductive connection member 100 is welded to a battery. Although the two embossed structures 110a and 110b are formed in this embodiment, only one embossed structure or more than two embossed structures may be formed at the conductive connection member 100.

FIG. 8 is a partial sectional view illustrating an embossed structure of the conductive connection member shown in FIG. 7.

Referring to FIG. 8, an embossed structure 110 for connection with a battery (not shown) is formed at one end of the conductive connection member. At the bottom of the connection member is formed a protrusion 111, which will be brought into contact with the battery. At the top of the connection member opposite to the protrusion 111 is formed a depression 112, which will be brought into contact with one of the welding rods 310 and 320 (see FIG. 5), i.e., the welding rod 310. When electric current is supplied through one of the welding rods 310 and 320 of the resistance welding machine (not shown), i.e., the welding rod 310, the current concentrates on the protrusion 111, which is in contact with the battery, with the result that the protrusion 111 is heated first, and therefore, the temperature of the protrusion 111 reaches a melting temperature. At this time, a physical pressure is applied to the conductive connection member, and therefore, the coupling between the conductive connection member and the battery is accomplished.

The protrusion 111 of the embossed structure 110 is formed in the shape of a hemisphere having a radius of 0.4 mm. Of course, the size of the embossed structure 110 may be adjusted variously based on the size of the battery 200.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As apparent from the above description, the method of coupling the connection member to a desired device according to the present invention has the effect of substituting for nickel, which has low price competitiveness, and solving the problems caused during the welding process, thereby greatly improving the productivity and greatly reducing a possibility of defect.

1. A method of coupling a conductive member for electric connection ('connection member) to a desired device by welding, wherein the connection member includes a corrosion prevention coating layer formed on a plate body of a high electrical conductivity and an embossed structure formed at one end thereof, and wherein the method comprises locating the connection member such that a protrusion of the embossed structure is brought into contact with a predetermined region of the device, at which the connection member will be connected to the device, making a welding rod come into contact with a depression opposite to the protrusion, and performing resistance welding.

2. The method according to claim 1, wherein the resistance welding is carried out by a pair of welding rods having different electrode characteristics, one welding rod (a) being brought into contact with the depression of the connection member, the other welding rod (b) being brought into direct contact with the device.

3. The method according to claim 2, wherein electric current for the resistance welding flows successively through the welding rod (a), the connection member, the device, and the welding rod (b).

4. The method according to claim 1, wherein the device is a secondary battery, and the connection member is coupled to an electrode terminal of the secondary battery by the resistance welding.

5. A conductive connection member coupled to an electrode terminal of a secondary battery by resistance welding, wherein the connection member includes a corrosion prevention coating layer formed on a plate body of a high electrical conductivity and an embossed structure formed at one end thereof.

6. The connection member according to claim 5, wherein the plate body is made of a metal material having an electrical conductivity greater than that of nickel, and the corrosion prevention coating layer is made of a tin-based material.

7. The connection member according to claim 6, wherein the metal material having an electrical conductivity greater than that of the nickel is a copper-based material.

8. The connection member according to claim 7, wherein the copper-based material is copper or an alloy containing copper as a main component (a copper alloy).

9. The connection member according to claim 8, wherein the copper alloy is oxygen free copper, brass (60/40 or 70/30), or phosphorous bronze.

10. The connection member according to claim 6, wherein the tin-based material is tin or an alloy containing tin as a main component.

11. The connection member according to claim 5, wherein the corrosion prevention coating layer has a thickness of 2 to 8 μm.

12. The connection member according to claim 5, wherein the corrosion prevention coating layer is made of nickel.

13. The connection member according to claim 5, wherein the corrosion prevention coating layer is formed entirely or partially on one side or each side of the plate body.

14. The connection member according to claim 5, wherein the embossed structure is formed in the shape of a hemispheric protrusion having a radius of 0.4 to 1 mm.

15. A secondary battery the electrical connection of which is accomplished using a connection member according to claim 5.

16. The secondary battery according to claim 15, wherein the secondary battery is a cylindrical battery.
